(19) United States
(12) Patent Application Publication
(10) Pub. No.: US 2015/0128337 A1
(43) Pub. Date: May 14, 2015

(54) OFFSET SEAL CONFIGURATION FOR VACUUM SYSTEMS

(71) Applicant: MAG Aerospace Industries, LLC, Carson, CA (US)

(72) Inventors: David Beach, Seal Beach, CA (US); Howard Kuhns, Long Beach, CA (US); Joe Lauterio, Sunland, CA (US); Shane Nazari, Glendale, CA (US)

(21) Appl. No.: 14/525,336

(22) Filed: Oct. 28, 2014

Related U.S. Application Data
(60) Provisional application No. 61/902,906, filed on Nov. 12, 2013.

(51) Int. Cl. E03D 5/00; E03D 11/13; B64D 11/02

(52) U.S. Cl. CPC E03D 5/00; B64D 11/02; E03D 11/13
USPC 4/431; 4/252.6

(57) ABSTRACT

There is provided a seal configuration for use in connection with vacuum systems. The seal configuration finds particular use in vacuum waste flush systems, such as those used in passenger transport vehicles that have on-board lavatories with vacuum toilet systems. The seal configuration generally provides an offset configuration, which can result in a larger seal on the vacuum side. This can slightly delay the opening of the waste side seal with respect to the vacuum side seal of the system, proving an improved vacuum environment. This can also give the flow of waste a more direct transition across a vacuum plate as it flows through a flush valve.

### CROSS REFERENCE TO RELATED APPLICATIONS

This application claims the benefit of U.S. Provisional Application Ser. No. 61/902,906, filed Nov. 12, 2013, titled “Offset Seal Concept,” the entire contents of which are hereby incorporated by reference.

### FIELD OF THE DISCLOSURE

Embodiments of the present disclosure relate generally to a seal configuration for use in connection with vacuum systems. The seal configuration finds particular use in vacuum waste flush systems, but may be used in any other types of vacuum systems. The seal configuration also finds particular use in passenger transport vehicles that have on-board lavatories with vacuum toilet systems. The seal configuration generally provides an offset configuration, which can result in a larger seal on the vacuum side. This can slightly delay the opening of the waste side seal with respect to the vacuum side seal of the system, proving an improved vacuum environment. This can also give the flow of waste a more direct transition across a vacuum plate as it flows through a flush valve.

### BACKGROUND

Aircraft and other passenger transport vehicles typically have on-board lavatories with vacuum toilet systems. These systems typically include a waste-receiving toilet bowl connected to a main waste tank via a sewer pipe or main waste line. A discharge or flush valve is typically mounted on the sewer pipe to selectively allow fluid communication between the toilet bowl and the main waste tank. To power the toilet system, the waste reservoir is maintained under a pressure that is substantially lower than the pressure in the waste-receiving toilet bowl, which is typically under the near-atmospheric pressure of the aircraft's passenger cabin. Thus, when the discharge/flush valve is opened, the pressure differential between the bowl and the reservoir causes the waste in the bowl to be drawn through the pipe into the waste reservoir. (A pressure differential may also be generated via a vacuum generator, for example, if an aircraft is on-ground or if the system is used on a land or water-based vehicle.)

Discharge valves typically have a cylindrical housing with an inner chamber sized to contain a disk-shaped plate with an opening therein. One side of the housing has an inlet that is generally aligned with an outlet that is located on the opposite side of the housing. The waste-receiving toilet bowl is connected to the inlet by one portion of a sewer pipe, and the main waste tank is connected to the outlet of the valve housing via another portion of the sewer pipe.

A drive mechanism selectively rotates the disk-shaped plate between an open position and a closed position. In the open position, the opening in the disk-shaped plate is aligned between the inlet and the outlet, which allows fluid communication for the flushing of the vacuum toilet. In the closed position, the opening in the plate is moved away from the inlet and outlet area, such that it blocks fluid communication between the inlet and the outlet, preventing fluid from flowing between the bowl and the reservoir.

In vacuum waste systems, differential pressure is what drives the collected waste from the toilet bowl into the accumulation point (which is typically the main waste tank). The discharge valve should provide an interface for such a vacuum system without venting the pressure differential completely. It should also allow for the controlled addition of material into the ambient-pressure environment, while providing a leak-free obstruction that can be moved or rotated in a controlled manner so as to allow for the passage of a mixed media bolus from the ambient-pressure environment (e.g., the toilet bowl) to the low pressure environment (e.g., the waste tank). The discharge valve is then returned to its closed position in order to prevent further movement of waste into the waste tank until the next flush is activated. One example of a valve for use with a vacuum toilet is shown and described by co-owned U.S. Pat. No. 6,325,356.

While many discharge or flush valves are available that achieve these tasks, a number of problems have arisen associated with their reliability due to the deleterious nature of human waste on mechanical devices. For example, due to the high degree of differential pressure being controlled by the flush valve, waste may be ingested into the interior of the valve housing during the flush process, which contributes to corrosion of internal components. Additionally, ingested waste may dry and harden, preventing the actuation of the flush valve and significantly reducing the reliability of the valve. It is thus desirable to provide improved flush valves and seal configurations.

### BRIEF SUMMARY

Embodiments described herein thus provide a seal configuration with a generally offset configuration. This can result in a larger seal on the vacuum side. The configuration can slightly delay the opening of the waste side seal with respect to the vacuum side seal of the system, proving an improved vacuum environment. The configuration can also give the flow of waste a more direct transition across a vacuum plate as it flows through a flush valve.

In one example, there is provided a seal configuration for use in a vacuum flush system, comprising: a housing having a fluid inlet, a fluid outlet, and a conduit therebetween; a flush plate dividing the conduit into a vacuum-side and a waste-receptacle side, the flush plate having an opening for selectively allowing fluid passage through the opening; a vacuum-side seal on the vacuum-side of the flush plate, a waste-receptacle side seal on the waste-receptacle side of the flush plate, wherein the vacuum-side seal is offset from the waste-receptacle side seal.

### BRIEF DESCRIPTION OF THE DRAWINGS

FIG. 1 shows a side cross-sectional view of a portion of a vacuum flush system housing.

FIG. 2 shows a perspective cross-sectional view of the vacuum flush system housing of FIG. 1.

FIG. 3 shows a front perspective view of a vacuum flush system housing.

FIG. 4 shows a rear perspective view of a vacuum flush system housing.

FIG. 5A shows a cross sectional view of a vacuum flush system housing with the flush plate closing the waste conduit.

FIG. 5B shows a cross sectional view of a vacuum flush system housing with the flush plate beginning to break the vacuum side seal.

FIG. 5C shows a cross sectional view of a vacuum flush system housing with the flush plate beginning to break the waste side seal.

FIG. 5D shows a cross sectional view of a vacuum flush system housing with the flush plate opening the waste conduit.

FIG. 6 shows a cross sectional view of a vacuum flush system housing of the prior art, with concentric seals.

### DETAILED DESCRIPTION

Embodiments of the present invention provide an improved seal configuration 10 for use with a flush valve system 12. The flush valve system 12 may be used in connection with a vacuum toilet, but other flush valves may also implement the improves seal configuration described herein. Although the seal configuration 10 is described for use with a toilet system, and specifically for use with a vacuum toilet for use on-board a passenger vehicle such as an aircraft, it should be understood that this seal system may be used with any other system that seeks to use a valve across a pressure differential situation and/or a valve that can transport waste or any other form of media. Examples of alternate uses include but are not limited to facility-based vacuum waste systems, facility-based vacuum transport systems, mixed media processes in oil and gas industries, conditional overboard venting in aerospace applications, or any other appropriate instance when a flush valve is needed.

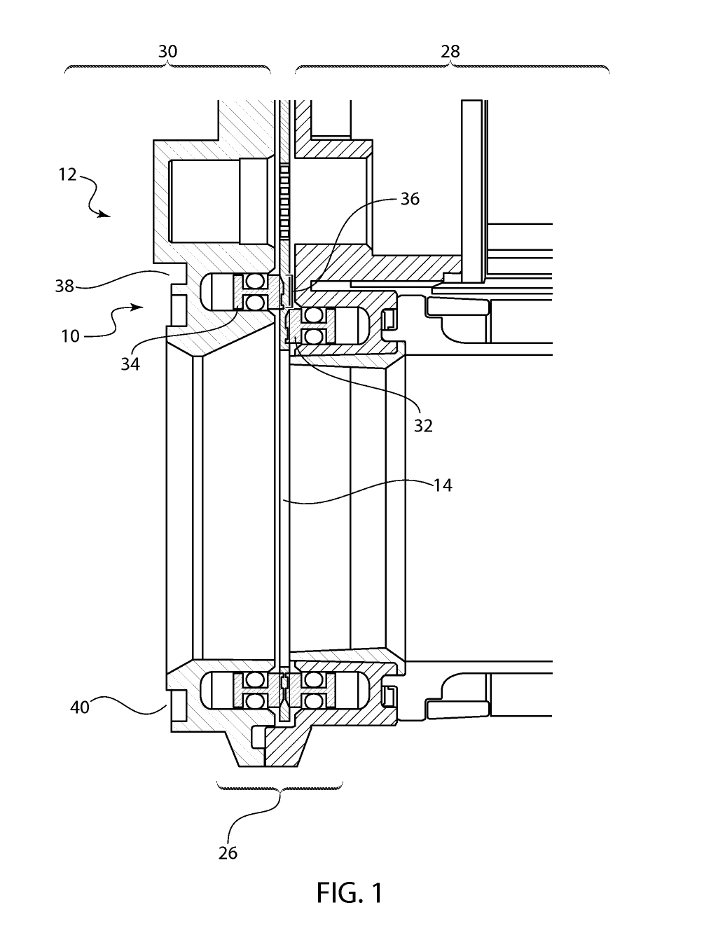

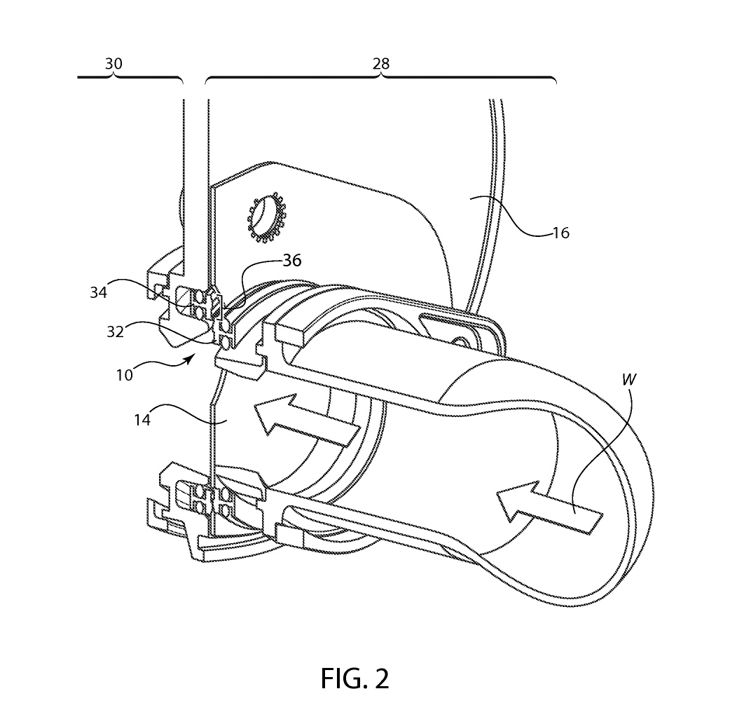

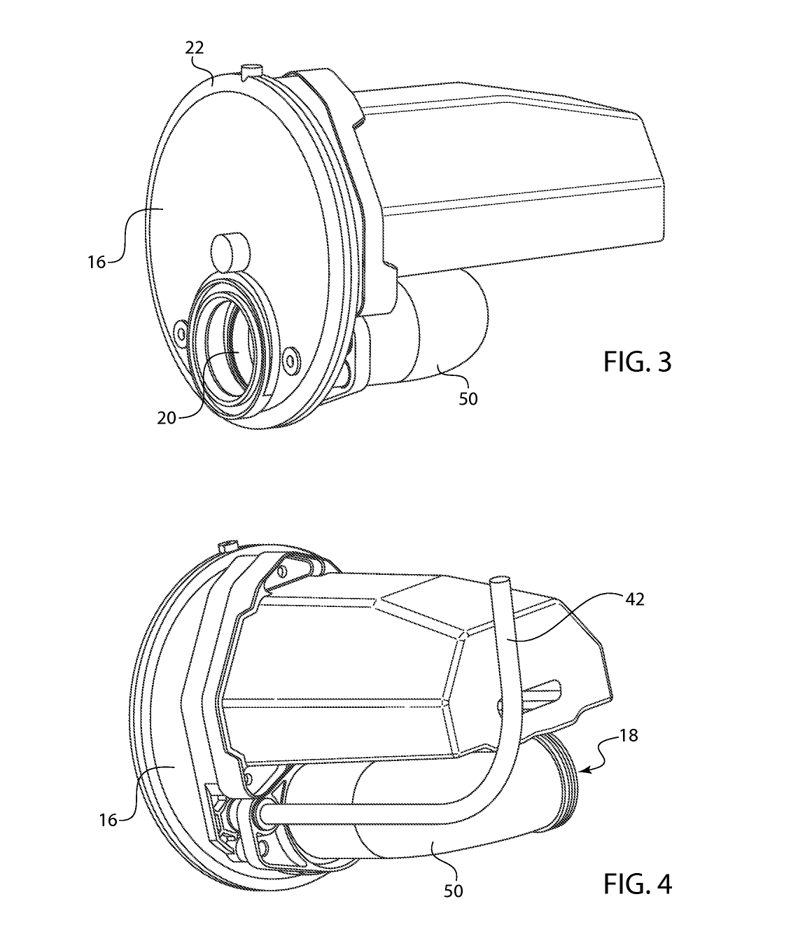

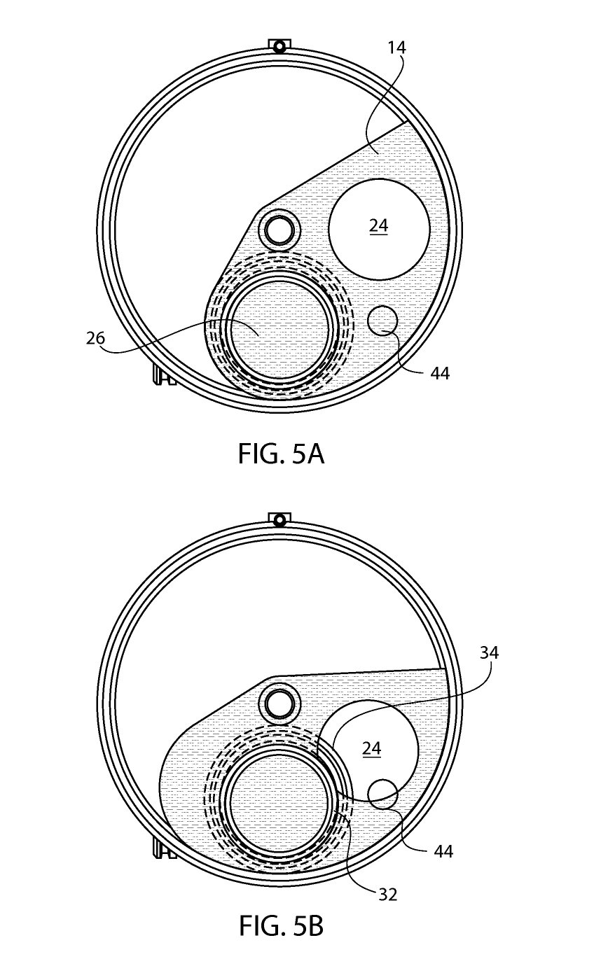

As shown in FIGS. 1 and 2, the improved seal configuration 10 may be used in connection with a flush valve 12 system. The flush valve system 12 is generally features a flush plate 14 that is enclosed in a valve housing 16. As shown in FIGS. 3 and 4, the valve housing 16 has a media/waste inlet 18 and a media/waste outlet 20. In use, the media/waste inlet 18 provides a connection for a conduit 50 (such as a sewer pipe) to a waste-receiving toilet bowl. Waste and/or other fluid media travels into the flush valve system 12 from the toilet bowl via conduit 50 and into inlet 18. The media/waste outlet 20 provides a connection for the conduit 50/sewer pipe to the main waste tank or other holding location, such that waste travels out of the flush valve system 12 through outlet 20. The flush plate 14 is generally formed as a plate that is interposed between the inlet 18 and the outlet 20.

The perspective views of the housing 16 shown in FIGS. 3 and 4 illustrate that the housing 16 may have a valve section 22 with a circumference. It should be understood, however, that the housing 16 and the valve section 22 may take on any appropriate or desired shape instead.

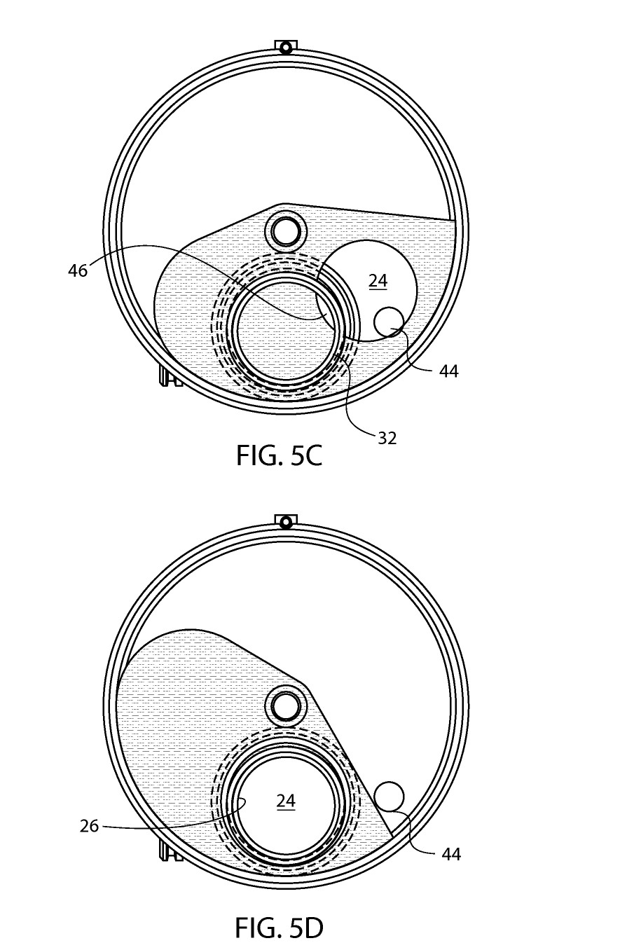

The cross-sectional views of FIGS. 5A-D illustrate the flush plate 14 as it is positioned within the housing 16. The flush plate 14 may be formed as portion of a pie-shaped wedge or a section of a circle. The flush plate, however, may have any other appropriate shape or configuration. The general goal is that the flush plate blocks flow through conduit in one configuration, and allows flow through the conduit in another configuration. In one embodiment, the plate 14 has an opening 24 that moves across an interface 26 in use. This interface 26 may be created by flush plate, as it is bound by seals, as outlined in more detail below. Movement of the flush plate 14 controls the opening and closing of the opening 24 , which is what either allows passage of fluid through the conduit 50 (from inlet 18 to outlet 20) or what stops/blocks the flow through conduit 50.

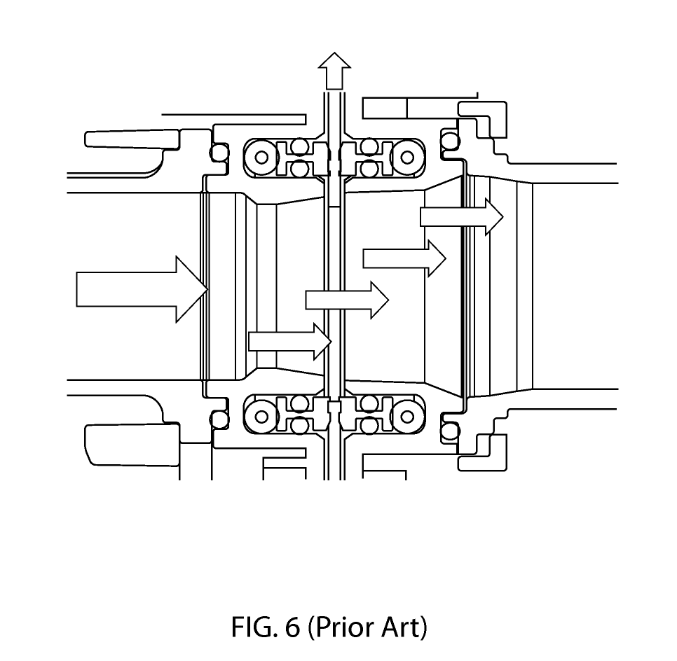

As shown in FIGS. 1 and 2, the housing has a waste receptacle side 28 and a vacuum side 30. There may be a seal 32 at the interface between the flush plate 14 and the waste receptacle side 28. There may also be a seal 34 at the interface between the other side of the flush plate 14 and the vacuum side 30. In previous systems, these seals were concentric with one another, as shown in FIG. 6. However, it has been found that by positioning the seals 32, 34 so that they are offset from one another, the chance of waste or other unwanted media entering the flush valve housing 16 can be reduced.

In a specific embodiment, the vacuum side seal 34 may be a larger seal than the waste side seal 32, such that when the seals 32, 34 are positioned against the flush plate 14, the vacuum side seal 34 is offset from the waste side seal 32 along at least one location. FIG. 1 shows the offset 36 being at the upper portion 38 of the housing 16. This figure also shows that the seals 32, 34 may generally align along at least some other portions of the housing 16, such as at the lower portion 40 of the housing 16. However, it should be understood that the offset 36 maybe larger or smaller than shown, and may be positioned in different locations than shown. Because the vacuum side seal 34 is larger than the waste side seal 32, the vacuum side seal 34 breaks first. This provides certain advantages.

One advantage is that by providing a larger vacuum side seal 34, the waste flow “W” can be prevented from getting caught along any vacuum side 30 seal edges. As shown in FIG. 2, there is not a “ledge” or any other obstruction created by the vacuum side seal for the waste to traverse or otherwise travel with respect to. The offset seal configuration provided can give the waste flow “W” a more direct path to flow into the waste outlet 20. This is in contrast to the concentric seal configuration of FIG. 6. When concentric seals of the prior art were used, there were instances of waste being pulled into the flush valve system and into the housing 16 (as shown by the upward arrow in FIG. 6), rather than being moved directly through the system, as desired. The offset position and larger size of the vacuum side seal 34 thus helps to prevent the ingestion of media into the interior of the valve during both the static condition of the valve, as well as during actuation of the valve. As shown by the perspective view of FIG. 2, the flow of waste around the flush plate 14 has a more direct path across the flush plate 14. A portion of the seal 34 may be recessed, such that it does not interfere with waste flow in any way. (Although only the upper portion of the seal 34 is shown as offset from the other seal 32, it is possible for both the upper and lower portions to be offset.)

Another advantage of the described seal configuration 10 is that it causes the vacuum side 30 to be exposed to vacuum before the waste receptacle side 28 is exposed to vacuum. As shown in FIG. 5A, when the opening 24 of the flush plate 14 is not aligned with conduit 50, waste is prevented/blocked from flowing between the inlet 18 and the outlet 20 of the hosing 16. As shown in FIG. 5B, when the opening 24 of the flush plate 14 approaches the vacuum side seal 34, this seal 34 is caused to break first. This is due to the offset nature of the vacuum side seal 34 with respect to the waste side seal 32. Opening of the vacuum side seal 34 allows air to flow in through the vent opening 44 before the waste side seal 32 opens.

The movement of the flush plate 14 is controlled by driving action of an actuator/motor, which is transferred by a gear assembly. The actuator/motor is controlled by a position sensing mechanism, which allows the flush plate 14 to move. The flush plate 14 can be moved to block the interface 26 between the inlet 18 and the outlet 20 (i.e., when it is moved to a nonalignment positioned with the inlet and the outlet), preventing any transfer of vacuum or transfer of waste from an ambient-pressure environment on the inlet side to a low pressure environment on the outlet side.

Continued movement of the flush plate 14 as shown in FIG. 5C then causes the waste side seal 32 to break. A small part 46 of the opening 24 begins to allow vacuum to be applied to the fluid in the conduit 50, such that fluid can pass across the interface 26. The practical effect of this offset breaking of the seals 32, 34 is that the abrupt change in pressure is lessened.

Continued movement of the flush plate 14 causes the opening 24 to align with the conduit 50 as shown in FIG. 5D. This provides a fluid passageway between the toilet bowl and the waste tank. Once the opening 24 of the flush plate 14 aligns with the conduit 50, the waste flow is caused to travel into the inlet 18, though the flush plate opening 24, and out through the outlet 20, due to vacuum pressure. The path that the fluid takes while crossing the flush plate 14 can be more direct to the waste outlet 20, and less waste is transferred to the housing, due to the offset of the seals 32, 34.

As described, because the vacuum side seal 34 breaks first and venting is allowed, by the time the flush plate opening 24 moves to allow the waste receptacle side seal 32 to break, there is a smaller change in pressure. This results in less pressure that may otherwise attempt to pull waste flow into the housing, rather than causing its movement through the housing. The lowered pressure change between the waste receptacle side 28 and the vacuum side 30 can minimize the occurrence of a high pressure that can pull waste into the housing. This is in contrast to systems that provide concentric seals that open at the same time.

With the prior art concentric seals, the seals are opened at the same time. As soon as the seals are opened, the vacuum pressure inside the housing experiences an abrupt drop, which can pull waste into the housing. Providing offset seals that expose the vacuum side to vacuum first (and consequently, by slightly delaying when the waste side is exposed to vacuum) allows a 2-stage pressure difference. The pressure differential between the two sides can be staged, rather than applying pressure equally and simultaneously. This lowered pressure difference allows time for the housing to vent. The pressure in the housing cavity can be lowered. By the time that the waste is introduced, there is less pressure influence on the waste to be pulled into the housing cavity. The internal pressure of the housing can be more equalized, and instead of some particles of waste being pulled into crevices of the housing , the waste flow is encouraged to move more smoothly and directly across the flush plate 14. FIG. 4 shows a housing vent 42, which is the body of the vent opening 44.

Although the figures show the seals 32, 34 against the flush plate 14 as having a generally circular circumference, it should be understood that other shapes and configurations are possible. For example, the seals may be oval shaped, kidney shaped, oblong, triangular, or any other appropriate shape or configuration.

Additionally, although the seals are shown as I-beam seals in cross-sectional view, it should be understood that any other type of seal may be used instead. For example, the seals may be o-ring seals, trapezoidal seals, square seals, or any other seals that are appropriate for use with a vacuum system. The seals may be inserted into grooves of the flush plate or they may lie flush against a flush plate surface.

The seals may be made of any appropriate material as well. For example, they may be elastomeric, plastic, nylon, a flouropolymer, or any other materials. The seals may also be coated with various greases, oils or talcums, or other lubricants.

Changes and modifications, additions and deletions may be made to the structures and methods recited above and shown in the drawings without departing from the scope or spirit of the invention and the following claims.

What is claimed is:

1. A seal configuration for use in a vacuum flush system, comprising:
a housing having a fluid inlet, a fluid outlet, and a conduit therebetween;
a flush plate dividing the conduit into a vacuum-side and a waste-receptacle side, the flush plate having an opening for selectively allowing fluid passage through the opening;
a vacuum-side seal on the vacuum-side of the flush plate,
a waste-receptacle side seal on the waste-receptacle side of the flush plate,
wherein the vacuum-side seal is offset from the waste-receptacle side seal.

2. The seal configuration of claim 1, wherein movement of the flush plate causes the vacuum-side seal to break before the waste-side seal.

3. The seal configuration of claim 1, wherein the vacuum-side seal is larger than the waste-receptacle side seal, such that the vacuum side seal breaks first.

4. The seal configuration of claim 1, further comprising a vent opening.

5. The seal configuration of claim 1, wherein the seals comprise I-beam seals.

6. The seal configuration of claim 1, wherein the vacuum flush system is designed to transport waste from a waste-receptacle to a holding location.

7. The seal configuration of claim 1, wherein the vacuum flush system is installed on-board a passenger transport vehicle.

8. A vacuum flush system, comprising:
a vacuum source;
a waste-receptacle;
a conduit between the vacuum source and the waste receptacle for causing movement of fluid therebetween;
a housing with a flush plate dividing the housing into a vacuum source-side and a waste-receptacle side, the flush plate having an opening for selectively allowing fluid passage through the opening;
a vacuum-side seal on the vacuum-side of the flush plate,
a waste-receptacle side seal on the waste-receptacle side of the flush plate,
wherein the vacuum-side seal is larger than and offset from the waste-receptacle side seal.

9. The vacuum flush system of claim 8, wherein movement of the flush plate causes the vacuum-side seal to break before the waste-side seal.

10. The vacuum flush system of claim 8, further comprising a vent opening.

11. The vacuum flush system of claim 8, wherein the vacuum-side seal and the waste-receptacle side seal comprise I-beam seals.

12. The vacuum flush system of claim 8, wherein the vacuum flush system is designed to transport waste from the waste-receptacle to a holding location via vacuum pressure from the vacuum source.

13. An offset seal configuration, comprising:
a movable structure positioned between first and second seals,
wherein the first seal is offset with respect to the second seal, such that a cross section of the movable structure and the first and second seals shows that the first and second seals are non-concentric.

14. The offset seal configuration of claim 13, wherein the movable structure comprises a flush plate.

15. The offset seal configuration of claims 13 positioned in a vacuum flush system on-board a passenger transport vehicle.
